(19) United States
(12) Patent Application Publication
(10) Pub. No.: US 2026/0080642 A1
(43) Pub. Date: Mar. 19, 2026

(54) DAMAGE MAPPING OF VEHICLES FROM 2-DIMENSIONAL IMAGES TO 3-DIMENSIONAL MODELS

(71) Applicant: Capital One Services, LLC, McLean, VA (US)

(72) Inventors: Debashish ROY, Bangalore (IN); Amrit Presanna KUMAR, Bangalore (IN); Anuj CHAUDHARY, Bangalore (IN); Dontula KARTHIK, Bangalore (IN)

(73) Assignee: Capital One Services, LLC, McLean, VA (US)

(21) Appl. No.: 18/887,109

(22) Filed: Sep. 17, 2024

(51) Int. Cl. G06T 19/20; G06T 3/40; G06T 7/33; G06T 7/50; G06T 7/73; G06V 10/25

(52) U.S. Cl. CPC G06T 19/20; G06T 3/40; G06T 7/344; G06T 7/50; G06T 7/73; G06V 10/25; G06T 2200/24; G06T 2219/004; G06T 2219/2004; G06V 2201/08

(57) ABSTRACT

Aspects disclosed provide systems and methods for mapping damage from a two-dimensional (2D) image of a vehicle to a three-dimensional (3D) computer model of the vehicle. The system achieves this through various transformations and translation of pixel positions in the 2D image to a 3D computer model. Once the transformation and translations are performed, a graphical user interface (GUI) may be rendered indicating any damaged areas.

### TECHNICAL FIELD

Aspects relate to graphics processing and graphics rendering.

### BACKGROUND

Vehicles listed online through dealer or third-party websites often include images of the vehicles that show the interior and/or exterior of the vehicles to would be purchasers.

In the case of used vehicles, these listed vehicles may have damage to the exterior of the vehicle. This damage may or may not be readily visible from the images of the vehicle posted on the websites and dealers may or may not list the damage. Those interested in the vehicle, however, would like to know of any damage to a vehicle, as this affects their interest in the vehicle.

Thus, methods are needed to automatically identify damage to the exterior of a vehicle based on images taken of the vehicle.

### SUMMARY

Aspects disclosed herein provide a system and methods for mapping damage from a two-dimensional (2D) image of a vehicle to a three-dimensional (3D) computer model of the vehicle. The term vehicle as used herein will refer to an automobile (e.g., car, truck, etc.). However, the methods described herein may be adapted to other vehicles such as motorcycles, scooters, bicycles, boats, etc. A person of ordinary skill in the art (POSA) will recognize the changes necessary to make such adaptations after a reading of this disclosure.

The mapping disclosed will assist potential buyers by bringing to their attention damage to the exterior of vehicles being sold by dealers. Damage the potential buyers would otherwise not have visibly seen from the images themselves, or that may not be listed by the vehicle's dealer. The mapping is achieved by identifying damaged areas through image processing of the 2D image, and performing transformations and translations of the identified areas to map them onto a 3D computer model of the vehicle. Thus, the system and methods provide an improved approach to graphics processing and graphics rendering.

In aspects, the system can implement one or more computing devices to perform the aforementioned functionality. In aspects, the one or more computing devices can achieve the aforementioned functionality by first receiving the 2D image of the vehicle. The 2D image may be provided from a variety of sources. For example, the 2D image may be images taken by vehicle dealers with cameras. For the purposes of discussion with respect to this disclosure, the 2D images are assumed to be those of the exterior of the vehicle. In aspects, the 2D image may be those showing the vehicle from any angle (e.g., front, back, left, right, front-right, back-right, front-left, or back-left) of the vehicle. In aspects, once the 2D images are received, the system can detect, using a trained machine-learning model, a damaged area of the vehicle based on the 2D images. The machine-learning model will be discussed further below.

In aspects, and assuming that a damaged area is detected, the system can determine a bounding box for the damaged area. In aspects, a center point for the bounding box may be determined to represent a point of damage in the damaged area. In aspects, to translate the center point onto a 3D computer model, the system can retrieve a 3D computer model of the vehicle from a database storing such models. The 3D computer model can be a scaled version of the vehicle along with associated information and real-world dimensions of the vehicle as a part of the metadata of the model.

Once the 3D computer model is retrieved, the system can map coordinates of the center point to the 3D computer model. The details of how this mapping is performed will be discussed further below. In aspects, this mapping can include at least aligning the 3D computer model to align with the 2D image; scaling the 2D image to match a scale of the 3D computer model; and determining whether the 2D image has depth information for pixels of the 2D image. Based on these functions and other computations performed, which will be described in detail below, the 3D computer model and the 2D image may be aligned to be oriented in the same direction and to the same scale.

In aspects, once the 2D image and 3D computer model are aligned and oriented with each other and the coordinates are mapped, the system can generate an indication to overlay onto the center point. The indication may be a graphic indicating the point of damage to be displayed on the 3D computer model. In aspects, once the indication is overlaid onto the 3D computer model, the system can then generate a graphical user interface (GUI) for display on a device (e.g., a monitor, screen, tv, etc.), where the GUI includes renderings of the 2D image and the 3D computer model, and where the 3D computer model includes the indication. In aspects, the GUI may be displayed on a webpage to be displayed to the potential buyer visiting the website listing the vehicle for sale.

In aspects, if a damaged area is not detected, the system can proceed by retrieving the 3D computer model of the vehicle from the database and generate the GUI for display on a device. Unlike the case where a damaged area is detected, when no damaged area is detected, the GUI can include renderings of the 2D image and the 3D computer model without the indication.

Certain aspects have other steps or elements in addition to or in place of those mentioned above. The steps or elements will become apparent to a POSA from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a POSA to make and use the aspects.

FIG. 1 is an example system for mapping damage from a 2D image of a vehicle to a 3D computer model of the vehicle according to aspects.

FIG. 2 shows example orientations of a vehicle on which damaged areas may be detected according to aspects.

FIG. 3 shows an example method of operating the system according to aspects.

FIG. 4 shows an example GUI generated by the system according to aspects.

FIG. 5 is an example architecture of the components that may be used to implement the computing devices of the system according to aspects.

### DETAILED DESCRIPTION

Aspects disclosed herein provide a system and methods for mapping damage from a 2D image of a vehicle to a 3D computer model of the vehicle.

The system and methods provide a novel approach to graphics processing and graphics rendering, by introducing a technique for mapping damaged areas determined from a 2D image onto a 3D computer model. Such mapping requires computer aided transformations and translations of coordinates from the 2D image to the 3D computer model. The process requires a number of intermediary steps to perform the transformations and translations. Thus, aspects disclosed provide novel ways of image processing and rendering by allowing targeted mapping of desired points identified from 2D images to identical points on 3D computer models.

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of the disclosure. However, it will be apparent that the disclosure may be practiced without these specific details. In order to avoid obscuring an aspect of the present disclosure, some well-known circuits, system configurations, architectures, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for case of description and generally show similar orientations, this depiction in the figures is arbitrary for the most part. Generally, the disclosure may be operated in any orientation.

The term “module” or “unit” referred to herein may include software, hardware, or a combination thereof in an aspect of the present disclosure in accordance with the context in which the term is used. For example, the software may be machine code, firmware, embedded code, or application software. Also, for example, the hardware may be circuitry, a processor, a special purpose computer, an integrated circuit, integrated circuit cores, or a combination thereof. Further, if a module or unit is written in the system or apparatus claim section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

### System Overview and Function

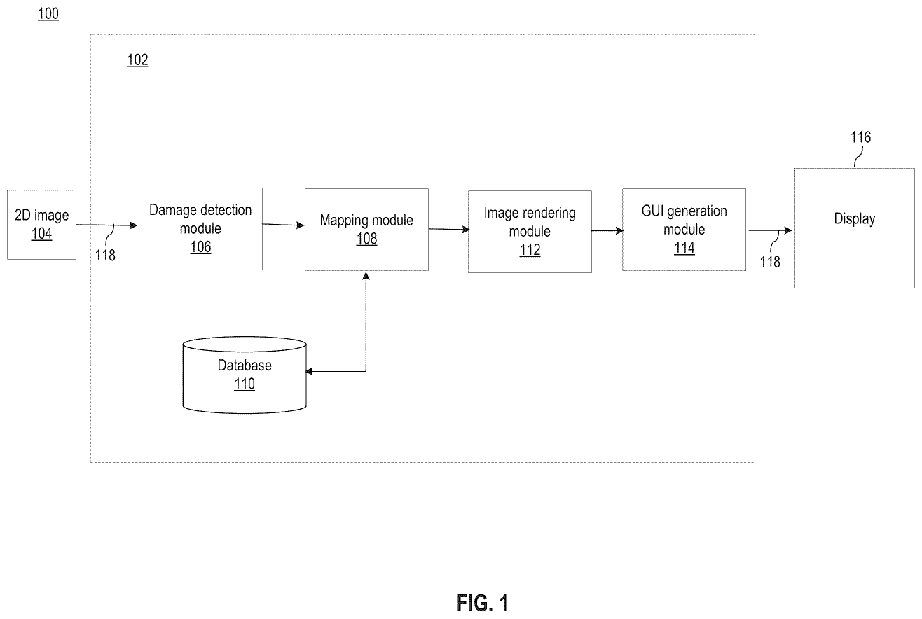

FIG. 1 is an example system 100 for mapping damage from a 2D image 104 of a vehicle to a 3D computer model of the vehicle according to aspects. In aspects, the system 100 may be implemented on one or more computing devices of backend computing infrastructure, including server infrastructure of a company, service, or platform listing the vehicles for sale on behalf of dealers. An example of such a service or platform may be the Auto Navigator™ platform of Capital One Financial Corporation, of Delaware.

The backend computing infrastructure of the system 100 may be housed in a cloud computing environment 102. The cloud computing environment 102 can include the server infrastructure. The cloud computing environment 102 may be a public or private cloud service. A private cloud refers to a cloud environment similar to a public cloud with the exception that it is operated solely for a single organization.

In aspects, the cloud computing environment 102 can comprise a variety of centralized or decentralized computing devices. For example, the cloud computing environment 102 may include a mobile device, a laptop computer, a desktop computer, grid-computing resources, a virtualized computing resource, cloud computing resources, peer-to-peer distributed computing devices, a server, a server farm, or a combination thereof. The cloud computing environment 102 may be centralized in a single room, distributed across different rooms, distributed across different geographic locations, or embedded within a network 118.

In aspects, and as shown in FIG. 1, the computing devices of the cloud computing environment 102 may have various software modules stored thereon to enable the functions of the system 100. In aspects, these modules can include a damage detection module 106, a mapping module 108, an image rendering module 112, and a GUI generation module 114. Each of these modules will be discussed in detail below.

The network 118 refers to a telecommunications network, such as a wired or wireless network. The network 118 can span and represent a variety of networks and network topologies. For example, the network 118 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 118. Cable, Ethernet, digital subscriber line (DSL), fiber optic lines, fiber to the home (FTTH), and plain old telephone service (POTS) are examples of wired communication that may be included in the network 118. Further, the network 118 can traverse a number of topologies and distances. For example, the network 118 can include a direct connection, personal area network (PAN), local area network (LAN), metropolitan area network (MAN), wide area network (WAN), or a combination thereof.

In aspects, and as shown in FIG. 1, the system 100 can perform its functions by first receiving a 2D image 104 of a vehicle. In aspects, the 2D image 104 may be obtained from an external source such as from a vehicle's dealer. For example, the vehicle's dealer can take pictures of the vehicle that may become the 2D image 104. In aspects, these images may be taken using any camera or similar device capable of taking pictures. These can include digital single-lens reflex (DSLR) cameras, film cameras, action cameras, mobile phones with integrated cameras, tablets with integrated cameras, etc. When taking pictures, these cameras or devices may include metadata for the pictures. For example, the cameras or devices can include geolocation information, timestamp information, depth information for the pixels, etc. Thus, in aspects the 2D image 104 can include the metadata as embedded information of the 2D image 104. In aspects, the images taken by the vehicle's dealer may be stored in databases, data stores, or repositories and may be retrieved by the system 100. In aspects, this retrieval may be through application programming interfaces (APIs) that connect the dealer's computing systems to the system 100.

In aspects, the 2D image 104 may be received by the damage detection module 106 via the network 118. The damage detection module 106 refers to a software program and/or class of software libraries that when executed by one or more computing devices, can detect a damaged area on the vehicle's exterior based on the 2D image 104. In aspects, the damage detection module 106 can implement a trained machine-learning model to detect the damaged area. The machine-learning model may be proprietary or open source. The machine-learning model may be, for example, a computer vision platform used for object detection, segmentation, and other visual recognition tasks. Alternatively, the machine-learning model may be a Mask Region-based Convolutional Neural Network (R-CNN) model customized and trained to detect the damaged area. The aforementioned are merely exemplary, and any other object detection, image processing, or computer vision model may be used to perform the detection as recognized by a POSA.

In aspects, the machine-learning model may be trained using a dataset for damage detection. Such a dataset may be based on images taken of various damages to exteriors of the vehicle or similar vehicles to the vehicle. In this way, the machine-learning model may be trained to recognize patterns that indicate damage to the exterior of a vehicle. The methods of training may be any known methods to a POSA. For example, this may be through supervised or unsupervised training methods, depending on the machine-learning model used. For example, supervised methods of training can include labeled images of known damage that may be fed into the machine-learning model to train the machine-learning model to recognize damage based on the labeling and classification. Over time, the machine-learning model may be tuned to set its weights and biases to an optimal setting to recognize damage based on what was previously labeled examples of damage. Such tuning may be done through backpropagation techniques and applying a cross-entropy loss function to the output of the machine-learning model, or similar techniques.

For the purposes of discussion, with respect to FIG. 1, it is assumed that the damage detection module 106 is capable of detecting a damaged area from the 2D image 104 using at least the aforementioned techniques. In aspects, based on the 2D image 104, the damage detection module 106 can determine whether or not the 2D image 104 of the vehicle has a damaged area. For the current purposes of the discussion, we will assume that the damage detection module 106 detects a damaged area from the 2D image 104. The situation where no damaged area is detected will be addressed later in this disclosure.

In aspects, assuming that the damage detection module 106 detects a damaged area, the damage detection module 106 can proceed to determining a bounding box for the damaged area. The bounding box refers to a square or rectangular area of the 2D image 104 that is believed to be damaged. In aspects, the bounding box may be a box of pixel length M×N, where M and N are the number of pixels bounding the box or rectangle. The bounding box may be determined in a variety of manners. For example, the damage detection module 106, using the machine-learning model, can determine a pattern indicating a damaged area and draw an M×N pixel box around that pattern. In aspects, once the bounding box is determined, the damage detection module 106 can proceed to determining a center point for the bounding box to represent a point of damage for the damaged area. The center point may be determined by determining which pixel or group of pixels are at the center of the bounding box and designating that pixel or group of pixels as the center point.

In aspects, once the damage detection module 106 has determined the center point, the damage detection module 106 can pass the 2D image and the information regarding the center point to the mapping module 108 for further processing. The mapping module 108 refers to a software program and/or class of software libraries that when executed by one or more computing devices, can map the center point to a 3D computer model of the vehicle. In aspects, in order to perform its function, the mapping module 108 has to retrieve the 3D computer model of the vehicle from a database 110. The database 110 refers to a data store or repository holding computer models of various vehicles. The computer models may be 3D renderings of vehicles, scaled to a particular size. The 3D computer model may be pre-generated and stored on the database 110. For the purposes of discussion with respect to FIG. 1, it is assumed that the database 110 has a 3D computer model of the vehicle. In aspects, the mapping module 108 can retrieve the 3D computer model of the vehicle via APIs or other function calls to the database 110.

In aspects, once the mapping module 108 obtains the 3D computer model, the mapping module 108 may proceed to map coordinates of the center point to the 3D computer model. To do this, intermediary steps need to be taken. In aspects, the first step that needs to be taken is to align the 3D computer model and the 2D image 104 so that the vehicle of both are oriented in the same direction and position. In aspects, this may be done aligning the 3D computer model in direction and position with the image of the vehicle in the 2D image 104. Once the image is aligned a coordinate system can be fixed to facilitate the mapping of coordinate values across the 3D computer model and the 2D image 104. Throughout this disclosure it will be assumed that the coordinate system is fixed at the center of the 3D computer model. This is by choice. In aspects, the coordinate system can be fixed to any part of the 3D computer model, so long as it is fixed on the 3D computer model, and calculations can be performed based on the fixed coordinate system.

In aspects, a scaling may be performed. The purpose of doing the scaling is to scale the vehicle shown in the 2D image 104 to the same scale as the 3D computer model. In this way, when mapping the center point to the 3D computer model, the mapping module 108 can operate on the same scale and perform the calculations to do so easily and more efficiently. In aspects, the scaling may be based on a scaling factor. In aspects the scaling factor may be determined based on the equation shown in (1), below:

$$S F = ( W\_ 3 D ) / ( W\_ 2 D ) \qquad ( 1 )$$

In equation (1), SF is the scaling factor, W_3D is a width of the vehicle in the 3D computer model, and W_2D is a width of the vehicle in the 2D image 104. In aspects, the scaling may be done by multiplying SF by the coordinate values of the pixels of the vehicle in the 2D image 104.

In aspects, once the scaling is performed, the mapping module 108 can determine whether the 2D image 104 has depth information for pixels of the 2D image 104. In aspects, and as known by a POSA, most modern cameras have capabilities to provide depth information for the pixels indicating how far objects or points in the image taken are, from a position where the image was taken from. This depth information may be stored as a part of the image metadata. In aspects, whether the 2D image 104 has depth information will dictate what further processing is to be performed as will be described in detail below.

Continuing with the example, and assuming the mapping module 108 determines whether or not depth information is known from the 2D image 104, the mapping module can proceed to determine where on the vehicle the center point is located. For the purposes of discussion, we will assume four areas where the damaged area may be located. These include a front of the vehicle, back of the vehicle, left hand side of the vehicle, and right hand side of the vehicle. In aspects, determining where on the vehicle the center point is located will also dictate what further processing is to be performed as well.

In the proceeding paragraphs, the further processing required for the mapping to take place will be described in detail. For the purposes of discussion, damage to the front or back of the vehicle will be considered together and damage to the left or right of the vehicle will be considered together. The equations described below are based on damages found at the left and front side of the vehicle. These equations, however, may be extended to situations where the damaged area is found to be on the right and back side of the vehicle, as will be recognized by a POSA reading this disclosure.

### Assuming the Center Point is on the Left/Right of the Vehicle and Depth Information is Known

To describe the further processing required for the mapping of the center point to take place, we first assume the case where the center point is determined to be on the left or right side of the vehicle, and depth information is known from the 2D image 104.

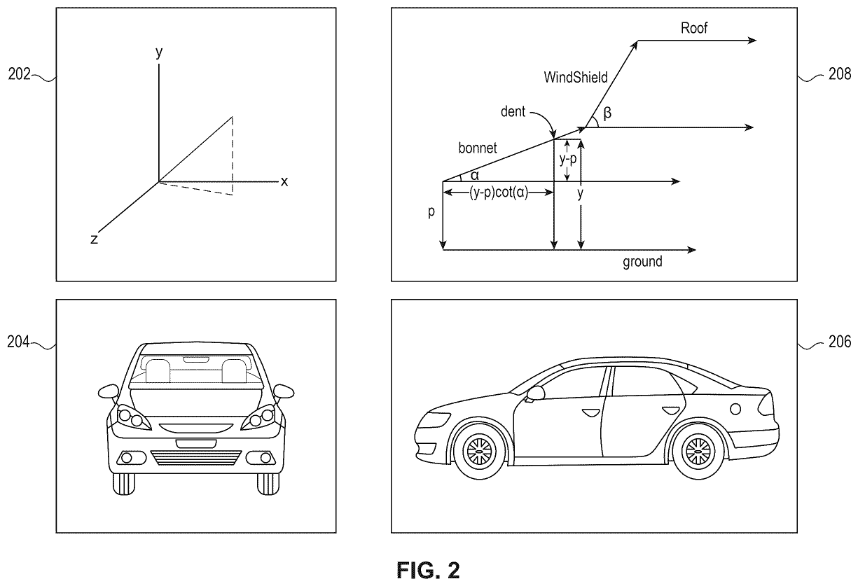

In aspects, in this situation, the mapping module 108 can proceed by first setting a coordinate system of the 3D computer model. The coordinate system refers to a fundamental space of geometry intended to represent physical space. For purposes of discussion, we assume the coordinate system is chosen to be a Euclidean space, with (x, y, z) coordinates representing values of an x-coordinate, a y-coordinate, and a z-coordinate of pixels of an object. An example coordinate system is shown in FIG. 2 as element 202. The coordinate system can form the basis for determining the coordinate position of the center point, and may be used in the mapping the center point to coordinates of the 3D computer model. In aspects, and as previously mentioned, throughout this disclosure, it is assumed that the coordinate system is fixed to the center of the 3D computer model and the calculations performed as based on the same. However, the coordinate system may be fixed on any part of the 3D computer model so long as it is fixed to the 3D computer model. The calculations will vary based on the origin of the coordinate system as will be recognized by a POSA.

In aspects, the coordinate system may be set to anywhere on the 3D computer model as long as it is attached to the model itself. For the purposes of discussion, and for simplicity, it is assumed that the coordinate system is chosen to be the center of the 3D computer model (which in this case is the 3D computer model of the vehicle). The x-axis representing the values of the x-coordinate will be along the length of the 3D computer model, the y-axis representing the values of the y-coordinate will be along the height of the 3D computer model, and the z-axis representing values of the z-coordinate will be along the width of the 3D computer model. The positive x-axis direction will be towards the front of the 3D computer model, the positive y-axis direction will be towards the top of the 3D computer model, and the positive z-axis direction will be towards the left hand side of the 3D computer model when looking at the 3D computer model from the front.

In aspects, based on the chosen coordinate system, the mapping module 108 can perform a translation of the coordinates of the center point. In this case, because the center point is located on the left side or the right side of the vehicle and the depth information for the center point is known, the translation of the center point to the 3D computer model may be done by a scaling. Assuming the center point is found to be on the left side of the vehicle, the translation is shown by equation (2) below:

$$( ( x - coordinate * SF ) - l / 2 , ( y - coordinate * SF ) - ( h / 2 ) , - w / 2 ) \qquad ( 2 )$$

In equation (2), x-coordinate is a x-coordinate of the center point, y-coordinate is a y-coordinate of the center point, SF is the scaling factor, l is the length of the vehicle in the 3D computer model, h is the height of the vehicle in the 3D computer model, and w is the width of the vehicle in the 3D computer model.

In aspects, if the damage is on the right side of the vehicle, equation (3), shown below can be used:

$$( ( x - coordinate * SF ) - l / 2 , ( y - coordinate * SF ) - ( h / 2 ) , w / 2 ) \qquad ( 3 )$$

In aspects, once the translation is performed, the mapping module 108 can generate an indication to be at the translated point. The indication may be a graphic indicating the point of damage on the 3D computer model. The indication may be rendered and overlaid onto the 3D computer model and be displayed on the 3D computer model in a GUI.

Assuming the Center Point is on the Front/Back of the Vehicle and Depth Information is Known

In aspects, assuming the case where the center point is determined to be on the front or back of the vehicle and depth information is known from the 2D image 104, the mapping module 108 can perform the translation by, first setting the coordinate system of the 3D computer model, similar to what was described above. Again, assuming the coordinate system is the center of the 3D computer model and assuming the center point is found to be on the front of the vehicle, the translation may be performed based on equation (4), shown below:

$$( l / 2 - ( x - coordinate * SF ) , ( y - coordinate * SF ) - h / 2 , ( z - coordinate * SF ) - w / 2 ) \qquad ( 4 )$$

In equation (4), a x-coordinate is the x-coordinate of the center point, y-coordinate is a y-coordinate of the center point, z-coordinate is a z-coordinate of the center point, SF is the scaling factor, l is the length of the vehicle in the 3D computer model, h is the height of the vehicle in the 3D computer model, and w is the width of the vehicle in the 3D computer model.

In aspects, once the translation is performed, the mapping module 108 can generate the indication to be at the translated point, similar to what was described above.

### Assuming the Center Point is on the Left/Right of the Vehicle and Depth Information is not Known

We now consider the cases where the depth information is not known from the 2D image 104. In this case, the mapping module 108 can compute an estimated depth for the center point. In aspects, this may be done by first setting the coordinate system of the 3D computer model, similar to what was described above. Again, assuming the coordinate system is at the center of the 3D computer model and assuming the center point is found to be on the left side of the vehicle, the mapping module 108 performs the translation based on equation (5), shown below:

$$( ( x - coordinate * SF ) - l / 2 , ( y - coordinate * SF ) - h / 2 , - w / 2 ) \qquad ( 5 )$$

In equation (5), x-coordinate is the x-coordinate of the center point, y-coordinate is the y-coordinate of the center point, l is the length of the vehicle in the 3D computer model, h is the height of the vehicle in the 3D computer model, and w is the width of the vehicle in the 3D computer model.

In aspects, once the translation is performed, the mapping module 108 can generate the indication to be at the translated point, similar to what was described above.

### Assuming the Center Point is on the Front/Back of the Vehicle and Depth Information is not Known

In aspects, if the center point is determined to be on the front or back of the vehicle and depth information is not known, the mapping module 108 will need to make an additional determination of whether the center point is located above or below the vehicle's bonnet. This is because if the center point is above the vehicle's bonnet, the surface of vehicle is sloped and it may affect where exactly the center point is located (i.e., whether the damage is on the windshield, the roof, a mirror, etc. Thus, an estimation of where on the slope the center point is, needs to be made.

In aspects, if the mapping module 108 determines that the center point is below the bonnet, and the damage is on the front of the vehicle, the translation may be performed using equation (6), below:

$$( l / 2 , h / 2 - ( y - coordinate * SF ) , w / 2 - ( x - coordinate * SF ) ) \qquad ( 6 )$$

In equation (6), x-coordinate is an x-coordinate of the center point, y-coordinate is a y-coordinate of the center point, SF is the scaling factor, l is the length of the vehicle in the 3D computer model, h is the height of the vehicle in the 3D computer model, and w is the width of the vehicle in the 3D computer model. In aspects, once the translation is performed, the mapping module 108 can generate the indication to be at the translated point, similar to what was described above.

In aspects, if the mapping module 108 determines that the center point is above the bonnet, and the damage is on the front of the vehicle, the translation may be performed using equation (7), below:

$$( l / 2 - ( ( y - coordinate * SF ) - p ) * cot ( α ) , h / 2 - ( y - coordinate * SF ) , w / 2 - ( z - coordinate * SF ) ) \qquad ( 7 )$$

In equation (7), z-coordinate is an z-coordinate of the center point, y-coordinate is a y-coordinate of the center point, SF is the scaling factor, l is the length of the vehicle in the 3D computer model, h is the height of the vehicle in the 3D computer model, and w is the width of the vehicle in the 3D computer model, α is the angle between the bonnet and a ground the vehicle is on, p is the height of the bonnet from the ground, and cot is the cotangent function. In aspects, once the translation is performed, the mapping module 108 can generate the indication to be at the translated point, similar to what was described above.

### Image Rendering and GUI Generation

In aspects, once one of the above mentioned translations are performed, the mapping module can pass control and the translated coordinates to the image rendering module 112 to render the indication onto the 3D computer model so that the indication may be displayed on a GUI. The image rendering module 112 refers to a software program and/or class of software libraries that when executed by one or more computing devices, can render the indication onto the 3D computer model. The rendering may be performed in any manner known to a POSA. Such rendering may be performed by any known rendering engines, rendering systems, graphics engines, or renderers. In aspects, the image rendering module 112 can overlay the indication onto the 3D computer model or a copy of the 3D computer model to be displayed on the GUI. Software libraries, such as the Trimesh Python library may be used to overlay the indication onto the 3D computer model.

In aspects, the process by which the indication is overlaid may be as follows. First, the 3D computer model of the vehicle may be retrieved or a copy obtained from the database 110. Then a sphere with a predetermined radius is generated and color is applied to the sphere. The sphere may be the indication. Next, the sphere may be positioned according to the translation previously performed and at the translation point. Once positioned, the 3D computer model may be merged with a background scene that is to be used as the background graphic on which the 3D computer model will be displayed on the GUI. In aspects, once the 3D computer model is merged with the background scene, the sum total image may be saved to be used later in the GUI.

In aspects, once the image rendering of the 3D computer model is performed to overlay the indication, the system 100 can pass control to the GUI generation module 114. The GUI generation module 114 refers to a software program and/or class of software libraries that generates a GUI that may be displayed on display device. In aspects, the GUI generation module 114 can generate a webpage or parts of and/or frames of a webpage that may be displayed. In aspects, the webpage can include the 3D computer model that includes the indication, in addition to other information to be displayed in the vehicle listing, such as make and model information, vehicle ownership history, price, mileage, dealer information, financing information, etc. Thus, the webpage may be the vehicle listing that is to be listed on the website listing the vehicle for sale. A POSA will recognize the process by which a GUI may be generated and therefore the details of the process will not be discussed herein. For the purposes of discussion with respect to this disclosure, it is assumed that the GUI may be generated.

In aspects, the rendered 3D computer model may be deployed on the GUI using the Three.js library. The Three.js library is a cross-browser JavaScript library and API that may be used to display animated 3D computer graphics in a web browser using the WebGL, which is another JavaScript API for rendering high-performance interactive 3D and 2D graphics with any compatible web browser without the use of plug-ins. Once the GUI is generated, it may be deployed on a website and/or web server to be displayed to a potential purchaser of the vehicle. Box 116 represents a display on which the GUI may be displayed to a potential purchaser.

The functions of the system 100 may be performed by the modules or units of the backend computing devices of the system 100, for example the computing devices of the cloud computing environment 102. The modules or units may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100, or installed as a removable portion of the system 100.

FIG. 2 shows example orientations of a vehicle on which damaged areas may be detected according to aspects. The orientations shown in FIG. 2 show the different views used to make the translations according to what was discussed with respect to FIG. 1. Box 202 shows an example coordinate system that may be chosen. The coordinate system shown shows the Euclidean coordinate system with the (x, y, z) axes. The coordinate system may be used to attach to the 3D computer model as described above, and as a reference from which the computations shown above may be performed.

Boxes 204 and 206 show the two different orientations on which the computations described with respect to FIG. 1 are performed. Box 204 shows a front view of a vehicle, while box 206 shows a left hand view of the vehicle.

Box 208 shows the various angles and dimensions of the vehicle using a left view of the vehicle. The computations of equation (7), described above may be based on the various angles and dimensions of box 208.

### Methods of Operation

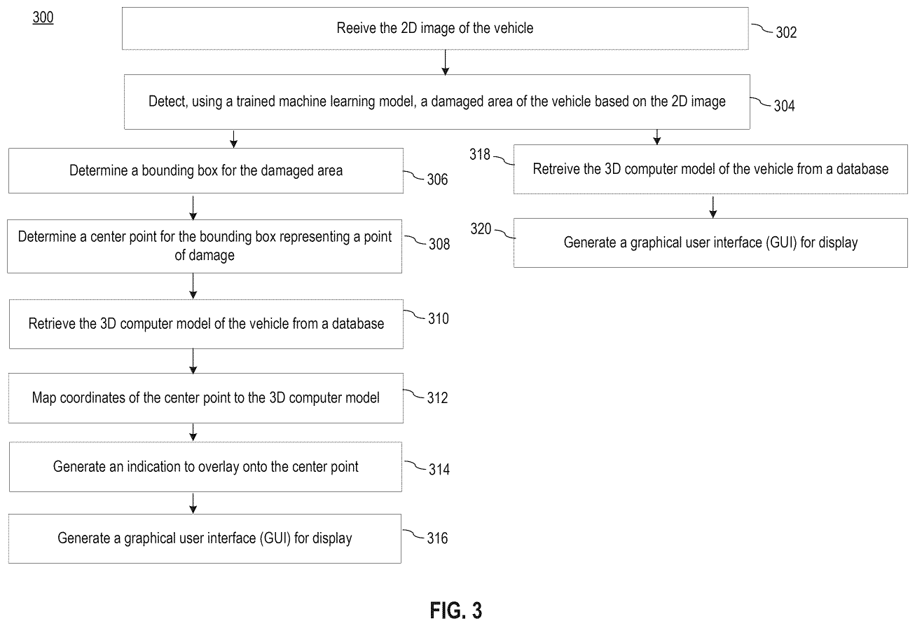

FIG. 3 shows an example method 300 of operating the system 100 according to aspects. Method 300 may be implemented on computing devices, for example the computing devices of the cloud computing environment 102.

In aspects, method 300 may begin by receiving the 2D image 104 of the vehicle, as shown in box 302. Once the 2D image 104 is received, the system 100 can detect, using a trained machine-learning model, a damaged area of the vehicle based on the 2D image 104, as shown by box 304. In aspects, if a damaged area is found, the system 100 can proceed down the left hand branch of method 300, and first determine a bounding box for the damaged area, as shown in box 306. Once the bounding box is determined, a center point for the bounding box may be determined, where the center point represents a point of damage, as shown in box 308. In aspects, once the center point is determined, the system 100 can retrieve a 3D computer model of the vehicle from a database 110. Once retrieved, the system can then proceed to map coordinates of the center point to the 3D computer model, as shown in box 312. Based on the mapping, the system 100 can then generate an indication to overlay onto the center point, as shown in box 314. Once the indication is overlaid, the system 100 can generate a graphical user interface (GUI) for display on a display device, where the GUI includes renderings of the 2D image and the 3D computer model, and where the 3D computer model includes the indication, as shown in box 316.

In aspects, if a damaged area is not detected by the system 100, the system 100 can proceed down the right hand branch of method 300, and first retrieve the 3D computer model of the vehicle from the database 110, as shown by box 318. The system 100 can then proceed to generate the GUI for display on a display device, where the GUI includes renderings of the 2D image and the 3D computer model, as shown in box 320.

The operation of method 300 is performed, for example, by system 100, in accordance with aspects described above. The functions described may be performed according to and consistent with FIGS. 1 and 2, and by the damage detection module 106, the mapping module 108, the image rendering module 112, and the GUI generation module 114 or their equivalents as described above. Such modules may be combined in various ways or manners to perform the functions described with respect to method 300.

### GUI Display

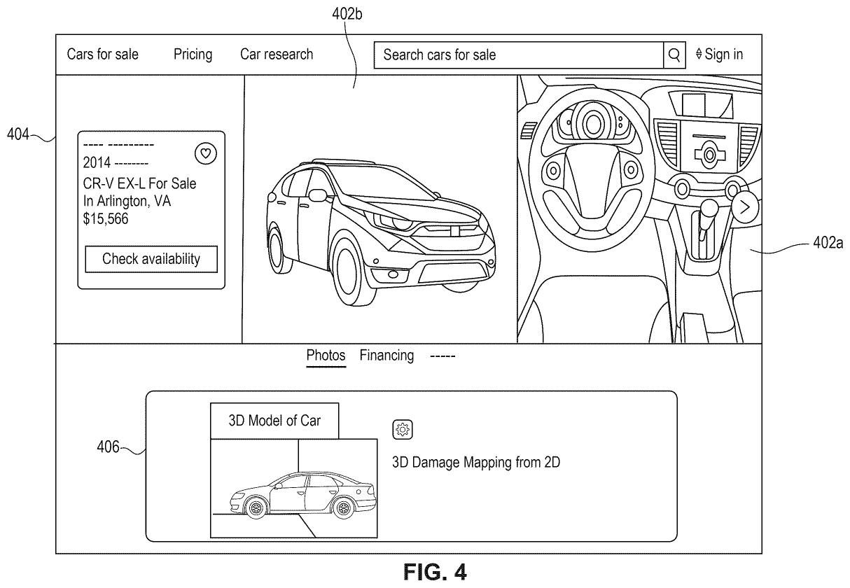

FIG. 4 shows an example GUI 400 generated by the system 100 according to aspects. The GUI 400 may be a sample webpage displaying the vehicle listing. As a part of the vehicle listing, the GUI 400 can display 2D image (e.g., images 402a, 402b) showing the inside and external body of the vehicle. In aspects, a further frame or pane of the website, shown as frame 404, can further display information about the vehicle, pertinent to a potential purchaser. This can include, for example, the make and model information, the location of the dealer, the price of the vehicle, the availability of the vehicle, etc.

In aspects, a further frame or pane of the website, shown as frame 406 can display the 3D computer model of the vehicle. Based on the determination by the system 100, whether the vehicle's exterior has damage or not, frame 406 can display the 3D computer model with or without the indication showing the damage. In accordance to the above descriptions with respect to FIGS. 1-3, a potential buyer viewing the website can rotate and manipulate the 3D computer model to view it from all angles and to determine whether there are any indications of damage. As such, the GUI provides a user friendly interface which purchasers can view the vehicle listing and determine whether the vehicle has damage according to implementation of the system 100. Such information is highly pertinent to a potential purchaser. Thus, the system 100, also enhances the user experience when purchasing the vehicle through technological advances in image processing and rendering.

### Components of the System

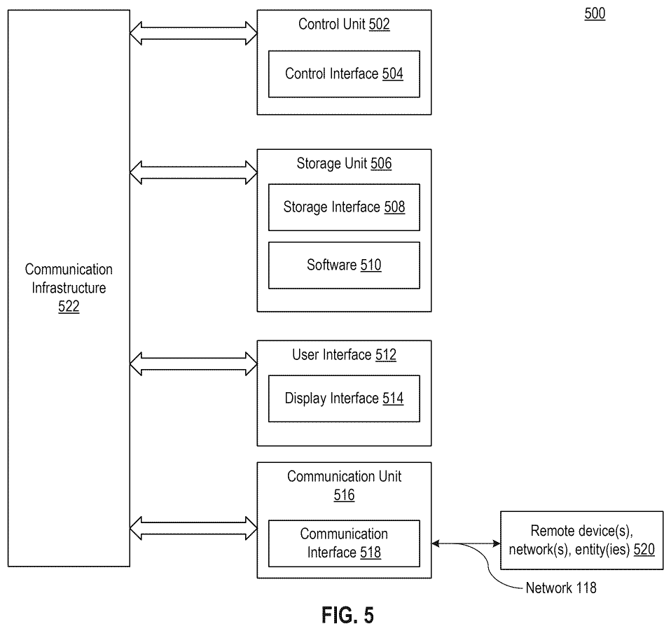

FIG. 5 is an example architecture 500 of the components that may be used to implement the computing devices of the system 100 according to aspects. The components may be implemented on any of the devices of the system 100, for example the computing devices of the cloud computing environment 102. In aspects, the components may include a control unit 502, a storage unit 506, a communication unit 516, and a user interface 512. The control unit 502 may include a control interface 504. The control unit 502 may execute software 510 to provide some or all of the intelligence of system 100. The control unit 502 may be implemented in a number of different ways. For example, the control unit 502 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 504 may be used for communication between the control unit 502 and other functional units or devices of system 100. The control interface 504 may also be used for communication that is external to the functional units or devices of system 100. The control interface 504 may receive information from the functional units or devices of system 100, or from remote devices 520, or may transmit information to the functional units or devices of system 100, or to remote devices 520. The remote devices 520 refer to devices external to system 100, such as any display devices that can display the webpage/website, as described with respect to FIGS. 1-4.

The control interface 504 may be implemented in different ways and may include different implementations depending on which functional units or devices of system 100 or remote devices 520 are being interfaced with the control unit 502. For example, the control interface 504 may be implemented with integrated circuits, optical circuitry, waveguides, wireless circuitry, wireline circuitry to attach to a bus, an API, or a combination thereof. The control interface 504 may be connected to a communication infrastructure 522, such as a bus, to interface with the functional units or devices of system 100 or remote devices 520.

The storage unit 506 may store the software 510. For illustrative purposes, the storage unit 506 is shown as a single element, although it is understood that the storage unit 506 may be a distribution of storage elements. Also for illustrative purposes, the storage unit 506 is shown as a single hierarchy storage system, although it is understood that the storage unit 506 may be in a different configuration. For example, the storage unit 506 may be formed with different storage technologies forming a memory hierarchical system including different levels of caching, main memory, rotating media, or off-line storage. The storage unit 506 may be a volatile memory, a nonvolatile memory, an internal memory, an external memory, or a combination thereof. For example, the storage unit 506 may be a nonvolatile storage such as nonvolatile random access memory (NVRAM), Flash memory, disk storage, or a volatile storage such as static random access memory (SRAM) or dynamic random access memory (DRAM).

The storage unit 506 may include a storage interface 508. The storage interface 508 may be used for communication between the storage unit 506 and other functional units or devices of system 100. The storage interface 508 may also be used for communication that is external to system 100. The storage interface 508 may receive information from the other functional units or devices of system 100 or from remote devices 520, or may transmit information to the other functional units or devices of system 100 or to remote devices 520. The storage interface 508 may include different implementations depending on which functional units or devices of system 100 or remote devices 520 are being interfaced with the storage unit 506. The storage interface 508 may be implemented with technologies and techniques similar to the implementation of the control interface 504.

The communication unit 516 may enable communication to devices, components, modules, or units of system 100 or to remote devices 520. For example, the communication unit 516 may permit the system 100 to communicate between the modules of the cloud computing environment 102. The communication unit 516 may further permit the devices of system 100 to communicate with remote devices 520 such as an attachment, a peripheral device, or a combination thereof, through the network 118.

As previously indicated, the network 118 may span and represent a variety of networks and network topologies. For example, the network 118 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 118. Cable, Ethernet, digital subscriber line (DSL), fiber optic lines, fiber to the home (FTTH), and plain old telephone service (POTS) are examples of wired communication that may be included in the network 118. Further, the network 118 may traverse a number of network topologies and distances. For example, the network 118 may include direct connection, personal area network (PAN), local area network (LAN), metropolitan area network (MAN), wide area network (WAN), or a combination thereof.

The communication unit 516 may also function as a communication hub allowing system 100 to function as part of the network 118 and not be limited to be an end point or terminal unit to the network 118. The communication unit 516 may include active and passive components, such as microelectronics, communications circuitry, Radio Frequency (RF) circuitry, or an antenna, for interaction with the network 118.

The communication unit 516 may include a communication interface 518. The communication interface 518 may be used for communication between the communication unit 516 and other functional units or devices of system 100 or to remote devices 520. The communication interface 518 may receive information from the other functional units or devices of system 100, or from remote devices 520, or may transmit information to the other functional units or devices of the system 100 or to remote devices 520. The communication interface 518 may include different implementations depending on which functional units or devices are being interfaced with the communication unit 516. The communication interface 518 may be implemented with technologies and techniques similar to the implementation of the control interface 504.

The user interface 512 may present information generated by system 100. In aspects, the user interface 512 allows a user to interface with the devices of system 100 or remote devices 520. The user interface 512 may include an input device and an output device. Examples of the input device of the user interface 512 may include a keypad, buttons, switches, touchpads, soft-keys, a keyboard, a mouse, or any combination thereof to provide data and communication inputs. Examples of the output device may include a display interface 514. The control unit 502 may operate the user interface 512 to present information generated by system 100. The control unit 502 may also execute the software 510 to present information generated by system 100, or to control other functional units of system 100. The display interface 514 may be any graphical user interface such as a display, a projector, a video screen, or any combination thereof.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as a POSA will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting methods and systems are cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the disclosure should be determined not by the aspects illustrated, but by the appended claims and their equivalents.

What is claimed is:

1. A computer-implemented method for mapping damage from a two-dimensional (2D) image of a vehicle to a three-dimensional (3D) computer model of the vehicle comprising:
receiving, by one or more computing devices, the 2D image of the vehicle;
detecting, by the one or more computing devices and using a trained machine-learning model, a damaged area of the vehicle based on the 2D image;
if the damaged area is detected:
determining, by the one or more computing devices, a bounding box for the damaged area,
determining, by the one or more computing devices, a center point for the bounding box representing a point of damage,
retrieving, by the one or more computing devices, the 3D computer model of the vehicle from a database,
mapping, by the one or more computing devices, coordinates of the center point to the 3D computer model,
generating, by the one or more computing devices, an indication to overlay onto the center point, and
generating, by the one or more computing devices, a graphical user interface (GUI) for display, wherein the GUI includes renderings of the 2D image and the 3D computer model, and wherein the 3D computer model includes the indication; and
if the damaged area is not detected:
retrieving, by the one or more computing devices, the 3D computer model of the vehicle from the database, and
generating, by the one or more computing devices, the GUI for display, wherein the GUI includes renderings of the 2D image and the 3D computer model.

2. The computer-implemented method of claim 1, wherein the mapping further comprises:
align, by the one or more computing devices, the 3D computer model to align with the 2D image;
scaling, by the one or more computing devices, the 2D image to match a scale of the 3D computer model; and
determining, by the one or more computing devices, whether the 2D image has depth information for pixels of the 2D image.

3. The computer-implemented method of claim 2, wherein the scaling is based on a scaling factor, and wherein the scaling factor is determined based on:
$$SF = ( W\_ 3 D ) / ( W\_ 2 D ) ,$$
wherein,
SF is the scaling factor,
W_3D is a width of the vehicle in the 3D computer model, and
W_2D is a width of the vehicle in the 2D image.

4. The computer-implemented method of claim 3, further comprising:
determining, by the one or more computing devices, whether the center point is:
on a left or a right side of the vehicle, or
on a front or a back side of the vehicle.

5. The computer-implemented method of claim 4, wherein:
if the center point is determined to be on the left or the right side of the vehicle, and the 2D image has depth information:
setting, by the one or more computing devices, a coordinate system of the 3D computer model to be the center of the 3D computer model;
translating, by the one or more computing device, coordinates of the center point based on the coordinate system and according to:
$$( ( x - coordinate * SF ) - l / 2 , ( y - coordinate * SF ) - ( h / 2 ) , - w / 2 ) ,$$
wherein,
x-coordinate is an x-coordinate of the center point,
y-coordinate is a y-coordinate of the center point,
SF is the scaling factor, and
l is a length of the vehicle in the 3D computer model,
h is a height of the vehicle in the 3D computer model, and
w is a width of the vehicle in the 3D computer model; and
setting, by the one or more computing devices, the indication to be at the translated center point.

6. The computer-implemented method of claim 4, wherein:
if the center point is determined to be on the front or the back of the vehicle, and the 2D image has depth information:
setting, by the one or more computing devices, a coordinate system of the 3D computer model to be the center of the 3D computer model;
translating, by the one or more computing devices, coordinates of the center point based on the coordinate system and according to:
$$( l / 2 - ( x - coordinate * S F ) , ( y - coordinate * S F ) - h / 2 , ( 𝓏 - coordinate * S F ) - w / 2 ) ,$$
wherein,
x-coordinate is a x-coordinate of the center point,
y-coordinate is a y-coordinate of the center point,
z-coordinate is a z-coordinate of the center point,
SF is the scaling factor,
l is a length of the vehicle in the 3D computer model,
h is a height of the vehicle in the 3D computer model, and
w is a width of the vehicle in the 3D computer model; and
setting, by the one or more computing devices, the indication to be at the translated coordinates.

7. The computer-implemented method of claim 4, wherein:
if the center point is determined to be on the left or the right side of the vehicle, and the 2D image does not have depth information:
setting, by the one or more computing devices, a coordinate system of the 3D computer model to be the center of the 3D computer model,
translating, by the one or more computing devices, coordinates of the center point based on the coordinate system and according to:
$$( ( x - coordinate * S F ) - l / 2 , ( y - coordinate * S F ) - h / 2 , - w / 2 ) ,$$
wherein,
x-coordinate is a x-coordinate of the center point,
y-coordinate is a y-coordinate of the center point,
l is a length of the vehicle scaled to the 3D computer model,
w is a width of the vehicle scaled to the 3D computer model,
h is a height of the vehicle scaled to the 3D computer model,
SF is the scaling factor, and
setting, by the one or more computing devices, the indication to be at the translated coordinates.

8. The computer-implemented method of claim 4, wherein:
if the center point is determined to be on the front or the back side of the vehicle, and the 2D image does not have depth information:
setting, by the one or more computing devices, a coordinate system of the 3D computer model to be the center of the 3D computer model,
determining, by the one or more computing devices, whether the center point is above or below a bonnet of the vehicle;
if the center point is determined to be below the bonnet:
translating, by the one or more computing devices, coordinates of the center point based on the coordinate system and according to:
$$( l / 2 , h / 2 - ( y - coordinate * S F ) , w / 2 - ( x - coordinate * S F ) ) ,$$
wherein,
x-coordinate is a x-coordinate of the center point,
y-coordinate is a y-coordinate of the center point,
SF is the scaling factor,
l is a length of the vehicle scaled to the 3D computer model,
w is a width of the vehicle scaled to the 3D computer model,
h is a height of the vehicle scaled to the 3D computer model; and
setting, by the one or more computing devices, the indication to be at the translated coordinates;
if the center point is determined to be above the bonnet:
translating, by the one or more computing devices, the coordinates of the center point based on the coordinate system and according to:
$$( l / 2 - ( ( y - coordinate * S F ) - p ) * cot ( α ) , h / 2 - ( y - coordinate * S F ) , w / 2 - ( 𝓏 - coordinate * S F ) ) ,$$
wherein,
z-coordinate is a z-coordinate of the center point,
y-coordinate is a y-coordinate of the center point,
SF is the scaling factor,
l is a length of the vehicle scaled to the 3D computer model,
w is a width of the vehicle scaled to the 3D computer model,
h is a height of the vehicle scaled to the 3D computer model,
p is the height of the bonnet from the ground, α, is an angle between the bonnet and a ground the vehicle is on, and
cot is a cotangent function; and
setting, by the one or more computing devices, the indication to be at the translated coordinates.

9. A non-transitory computer readable medium storing instructions, that when executed by one or more processors of a computing system, cause the one or more processors to perform operations for mapping damage from a two-dimensional (2D) image of a vehicle to a three-dimensional (3D) computer model of the vehicle, the operations comprising:
receiving the 2D image of the vehicle;
detecting, using a trained machine-learning model, a damaged area of the vehicle based on the 2D image;
if the damaged area is detected:
determining a bounding box for the damaged area,
determining a center point for the bounding box representing a point of damage,
retrieving the 3D computer model of the vehicle from a database,
mapping coordinates of the center point to the 3D computer model,
generating an indication to overlay onto the center point, and
generating a graphical user interface (GUI) for display, wherein the GUI includes renderings of the 2D image and the 3D computer model, and wherein the 3D computer model includes the indication; and
if the damaged area is not detected:
retrieving the 3D computer model of the vehicle from the database, and
generating the GUI for display, wherein the GUI includes renderings of the 2D image and the 3D computer model.

10. The non-transitory computer readable medium of claim 9, wherein the mapping further comprises:
aligning the 3D computer model to align with the 2D image;
scaling the 2D image to match a scale of the 3D computer model; and
determining whether the 2D image has depth information for pixels of the 2D image.

11. The non-transitory computer readable medium of claim 10, wherein the scaling is based on a scaling factor, and wherein the scaling factor is determined based on:
$$S F = ( W\_ 3 D ) / ( W\_ 2 D ) ,$$
wherein,
SF is the scaling factor,
W_3D is a width of the vehicle in the 3D computer model, and
W_2D is a width of the vehicle in the 2D image.

12. The non-transitory computer readable medium of claim 11, wherein the operations further comprise:
determining whether the center point is:
on a left or a right side of the vehicle, or
on a front or a back side of the vehicle.

13. The non-transitory computer readable medium of claim 12, wherein:
if the center point is determined to be on the left or the right side of the vehicle, and the 2D image has depth information, the operations further comprise:
setting a coordinate system of the 3D computer model to be the center of the 3D computer model;
translating coordinates of the center point based on the coordinate system and according to:
$$( ( x - coordinate * S F ) - l / 2 , ( y - coordinate * S F ) - h / 2 , - w / 2 ) ,$$
wherein,
x-coordinate is an x-coordinate of the center point,
y-coordinate is a y-coordinate of the center point,
SF is the scaling factor, and
l is a length of the vehicle in the 3D computer model,
h is a height of the vehicle in the 3D computer model, and
w is a width of the vehicle in the 3D computer model; and
setting the indication to be at the translated center point.

14. The non-transitory computer readable medium of claim 12, wherein:
if the center point is determined to be on the front or the back of the vehicle, and the 2D image has depth information, the operations further comprise:
setting a coordinate system of the 3D computer model to be the center of the 3D computer model;
translating coordinates of the center point based on the coordinate system and according to:
$$( l / 2 - ( x - coordinate * S F ) , ( y - coordinate * S F ) - h / 2 , ( 𝓏 - coordinate * S F ) - w / 2 ) ,$$
wherein,
x-coordinate is a x-coordinate of the center point,
y-coordinate is a y-coordinate of the center point,
z-coordinate is a z-coordinate of the center point,
SF is the scaling factor,
l is a length of the vehicle in the 3D computer model,
h is a height of the vehicle in the 3D computer model, and
w is a width of the vehicle in the 3D computer model; and
setting the indication to be at the translated coordinates.

15. The non-transitory computer readable medium of claim 12, wherein:
if the center point is determined to be on the left or the right side of the vehicle, and the 2D image does not have depth information, the operations further comprise:
setting a coordinate system of the 3D computer model to be the center of the 3D computer model,
translating coordinates of the center point based on the coordinate system and according to:
$$( ( x - coordinate * S F ) - l / 2 , ( y - coordinate * S F ) - h / 2 , - w / 2 ) ,$$
wherein,
x-coordinate is a x-coordinate of the center point,
y-coordinate is a y-coordinate of the center point,
l is a length of the vehicle scaled to the 3D computer model,
w is a width of the vehicle scaled to the 3D computer model,
h is a height of the vehicle scaled to the 3D computer model,
SF is the scaling factor, and
setting the indication to be at the translated coordinates.

16. The non-transitory computer readable medium of claim 12, wherein:
if the center point is determined to be on the front or the back side of the vehicle, and the 2D image does not have depth information, the operations further comprise:
setting a coordinate system of the 3D computer model to be the center of the 3D computer model;
determining whether the center point is above or below a bonnet of the vehicle;
if the center point is determined to be below the bonnet;
translating coordinates of the center point based on the coordinate system and according to:
(l/2,h/2−(y-coordinate*SF), w/2−(x-coordinate*SF)),
wherein,
x-coordinate is a x-coordinate of the center point,
y-coordinate is a y-coordinate of the center point,
SF is the scaling factor,
l is a length of the vehicle scaled to the 3D computer model,
w is a width of the vehicle scaled to the 3D computer model,
h is a height of the vehicle scaled to the 3D computer model; and
setting the indication to be at the translated coordinates;
if the center point is determined to be above the bonnet:
translating the coordinates of the center point based on the coordinate system and according to:
$$( l / 2 - ( ( y - coordinate * S F ) - p ) * cot ( α ) , h / 2 - ( y - coordinate * S F ) , w / 2 - ( 𝓏 - coordinate * S F ) ) ,$$
wherein,
z-coordinate is a z-coordinate of the center point,
y-coordinate is a y-coordinate of the center point,
SF is the scaling factor,
l is a length of the vehicle scaled to the 3D computer model,
w is a width of the vehicle scaled to the 3D computer model,
h is a height of the vehicle scaled to the 3D computer model,
p is the height of the bonnet from the ground,
α, is an angle between the bonnet and a ground the vehicle is on, and
cot is a cotangent function; and
setting the indication to be at the translated coordinates.

17. A computing system for mapping damage from a two-dimensional (2D) image of a vehicle to a three-dimensional (3D) computer model of the vehicle comprising:
a memory storing instructions; and
one or more processors, coupled to the memory, configured to process the stored instructions to:
receive the 2D image of the vehicle;
detect, using a trained machine-learning model, a damaged area of the vehicle based on the 2D image;
if the damaged area is detected:
determine a bounding box for the damaged area,
determine a center point for the bounding box representing a point of damage,
retrieve the 3D computer model of the vehicle from a database,
map coordinates of the center point to the 3D computer model,
generate an indication to overlay onto the center point, and
generate a graphical user interface (GUI) for display, wherein the GUI includes renderings of the 2D image and the 3D computer model, and wherein the 3D computer model includes the indication; and
if the damaged area is not detected:
retrieve the 3D computer model of the vehicle from the database, and
generate the GUI for display, wherein the GUI includes renderings of the 2D image and the 3D computer model.

18. The computing system of claim 17, wherein the one or more processors are further configured to map the coordinates by:
aligning the 3D computer model to align with the 2D image;
scaling the 2D image to match a scale of the 3D computer model; and
determining whether the 2D image has depth information for pixels of the 2D image.

19. The computing system of claim 18, wherein the one or more processors are further configured to scale the 2D image based on a scaling factor, and wherein the scaling factor is determined based on:
$$S F = ( W\_ 3 D ) / ( W\_ 2 D ) ,$$
wherein,
SF is the scaling factor,
W_3D is a width of the vehicle in the 3D computer model, and
W_2D is a width of the vehicle in the 2D image.

20. The computing system of claim 19, wherein the one or more processors are further configured to:
determine whether the center point is:
on a left or a right side of the vehicle, or
on a front or a back side of the vehicle.

21. The computing system of claim 20, wherein:
if the center point is determined to be on the left or the right side of the vehicle, and the 2D image has depth information, the one or more processors are further configured to:
set a coordinate system of the 3D computer model to be the center of the 3D computer model;
translate coordinates of the center point based on the coordinate system and according to:
$$( ( x - coordinate * S F ) - l / 2 , ( y - coordinate * S F ) - h / 2 , - w / 2 ) ,$$
wherein,
x-coordinate is an x-coordinate of the center point,
y-coordinate is a y-coordinate of the center point,
SF is the scaling factor, and
l is a length of the vehicle in the 3D computer model,
h is a height of the vehicle in the 3D computer model, and
w is a width of the vehicle in the 3D computer model; and
set the indication to be at the translated center point.

22. The computing system of claim 20, wherein:
if the center point is determined to be on the front or the back of the vehicle, and the 2D image has depth information, the one or more processors are further configured to:
set a coordinate system of the 3D computer model to be the center of the 3D computer model;
translate coordinates of the center point based on the coordinate system and according to:
$$( l / 2 - ( x - coordinate * S F ) , ( y - coordinate * S F ) - h / 2 , ( 𝓏 - coordinate * S F ) - w / 2 ) ,$$
wherein,
x-coordinate is a x-coordinate of the center point,
y-coordinate is a y-coordinate of the center point,
z-coordinate is a z-coordinate of the center point,
SF is the scaling factor,
l is a length of the vehicle in the 3D computer model,
h is a height of the vehicle in the 3D computer model, and
w is a width of the vehicle in the 3D computer model; and
set the indication to be at the translated coordinates.

23. The computing system of claim 20, wherein:
if the center point is determined to be on the left or the right side of the vehicle, and the 2D image does not have depth information, the one or more processors are further configured to:
set a coordinate system of the 3D computer model to be the center of the 3D computer model,
translate coordinates of the center point based on the coordinate system and according to:
$$( ( x - coordinate * S F ) - l / 2 , ( y - coordinate * S F ) - h / 2 , - w / 2 ) ,$$
wherein,
x-coordinate is a x-coordinate of the center point,
y-coordinate is a y-coordinate of the center point,
l is a length of the vehicle scaled to the 3D computer model,
w is a width of the vehicle scaled to the 3D computer model,
h is a height of the vehicle scaled to the 3D computer model,
SF is the scaling factor, and
set the indication to be at the translated coordinates.

24. The computing system of claim 20, wherein:
if the center point is determined to be on the front or the back side of the vehicle, and the 2D image does not have depth information, the one or more processors are further configured to:
set a coordinate system of the 3D computer model to be the center of the 3D computer model;
determine whether the center point is above or below a bonnet of the vehicle;
if the center point is determined to be below the bonnet;
translate coordinates of the center point based on the coordinate system and according to:
$$( l / 2 , h / 2 - ( y - coordinate * S F ) , w / 2 - ( x - coordinate * S F ) ) ,$$
wherein,
x-coordinate is a x-coordinate of the center point,
y-coordinate is a y-coordinate of the center point,
SF is the scaling factor,
l is a length of the vehicle scaled to the 3D computer model,
w is a width of the vehicle scaled to the 3D computer model,
h is a height of the vehicle scaled to the 3D computer model; and
set the indication to be at the translated coordinates;
if the center point is determined to be above the bonnet:
translate the coordinates of the center point based on the coordinate system and according to:
$$( l / 2 - ( ( y - coordinate * S F ) - p ) * cot ( α ) , h / 2 - ( y - coordinate * S F ) , w / 2 - ( 𝓏 - coordinate * S F )$$
wherein,
z-coordinate is a z-coordinate of the center point,
y-coordinate is a y-coordinate of the center point,
SF is the scaling factor,
l is a length of the vehicle scaled to the 3D computer model,
w is a width of the vehicle scaled to the 3D computer model,
h is a height of the vehicle scaled to the 3D computer model,
p is the height of the bonnet from the ground,
α, is an angle between the bonnet and a ground the vehicle is on, and
cot is a cotangent function; and
set the indication to be at the translated coordinates.
